(19) United States
(12) Patent Application Publication
(10) Pub. No.: US 2026/0283064 A1
(43) Pub. Date: Sep. 24, 2026

(54) REAL-TIME INTELLIGENT DETECTION AND PREVENTION CONTROL WARNING METHOD AND APPARATUS FOR HOLOGRAPHIC WHOLE-CHAIN GRAIN AND OIL PRODUCT QUALITY SAFETY

(71) Applicant: Academy of National Food and Strategic Reserve Administration, Beijing (CN)

(72) Inventors: Minghui ZHOU, Beijing (CN); Songxue WANG, Beijing (CN); Deyan LI, Beijing (CN); Jieqiong ZHANG, Beijing (CN); Bin DONG, Beijing (CN)

(21) Appl. No.: 19/430,582

(22) Filed: Dec. 23, 2025

(30) Foreign Application Priority Data
Mar. 18, 2025 (CN) 202510318243.8

(51) Int. Cl. A01B 79/00; G06Q 50/02

(52) U.S. Cl. CPC A01B 79/005; G06Q 50/02

(57) ABSTRACT

This application provides a real-time intelligent detection and prevention control warning method and apparatus for holographic whole-chain grain and oil product quality safety. The method includes: inputting a value of a main influencing factor at each preset location in a target planting region into a contaminant content prediction model to obtain a content of each contaminant in a crop planted at each preset location; acquiring a content of each contaminant in a production stage, a procurement stage, a storage stage, a processing stage, and a sales stage of a target grain and oil product; constructing a knowledge graph corresponding to each contaminant based on a threshold range of each contaminant, the content of each contaminant in each stage within a current cycle, and entities; and predicting a content of each contaminant in another stage within the next cycle, and performing prevention control warning.

### CROSS REFERENCE TO RELATED APPLICATION

This patent application claims the benefit and priority of Chinese Patent Application No. 2025103182438, filed with the China National Intellectual Property Administration on Mar. 18, 2025, the disclosure of which is incorporated by reference herein in its entirety as part of the present application.

### TECHNICAL FIELD

The present disclosure relates to the technical field of food safety, and in particular to a real-time intelligent detection and prevention control warning method and apparatus for holographic whole-chain grain and oil product quality safety.

### BACKGROUND

In recent years, frequent food safety crises have severely impacted human health and aroused widespread global concern. Therefore, real-time monitoring and prevention control warning for quality safety in all of the production, procurement, storage, processing, and sales stages of grain and oil products are crucial.

### SUMMARY

An objective of the present disclosure is to provide a real-time intelligent detection and prevention control warning method and apparatus for holographic whole-chain grain and oil product quality safety. The present disclosure enables real-time monitoring and prevention control warning for the content of the contaminant in the production, procurement, storage, processing, and sales stages of the grain and oil product.

To achieve the above objective, the present disclosure provides the following technical solutions.

A first aspect of the present disclosure provides a real-time intelligent detection and prevention control warning method for holographic whole-chain grain and oil product quality safety, including:
inputting, for any variety of crop planted in a target planting region, a value of a main influencing factor at each preset location in the target planting region within a current cycle into a contaminant content prediction model corresponding to the variety of crop, and obtaining a content of each contaminant in the variety of crop planted at each preset location, where the variety of crop is configured to produce a target grain and oil product; one cycle includes a production stage, a procurement stage, a storage stage, a processing stage, and a sales stage of the target grain and oil product; the contaminant content prediction model corresponding to the variety of crop is generated by training a convolutional neural network model based on the main influencing factor at each target sampling point in the target planting region within the current cycle and the content of the contaminant in the variety of crop planted at each target sampling point; and the main influencing factor is obtained by screening an environmental variable and a spatial structure variable;
determining the content of each contaminant in the variety of crop planted at each preset location and each target sampling point as a content of each contaminant in the production stage of the target grain and oil product;
determining a content of each contaminant in the variety of crop planted at each preset location and each target sampling point after harvesting as a content of each contaminant in the procurement stage of the target grain and oil product;
storing the variety of crop planted at each preset location and each target sampling point after procurement into a warehouse, determining a content of each contaminant at warehousing-in as a content of each contaminant in the storage stage of the target grain and oil product, and determining a content of each contaminant at warehousing-out as a content of each contaminant in the processing stage of the target grain and oil product;
processing the variety of crop after warehousing-out to obtain the target grain and oil product, and determining a content of each contaminant in the target grain and oil product for sale as a content of each contaminant in the sales stage of the target grain and oil product;
constructing a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain; and
predicting a content of each contaminant in the procurement stage, the storage stage, the processing stage, and the sales stage of the target grain and oil product within a next cycle based on the knowledge graph corresponding to each contaminant and a content of each contaminant in the production stage of the target grain and oil product within the next cycle to obtain predicted values; and performing prevention control warning based on the predicted values.

Optionally, the target sampling point is specifically determined by:
acquiring, for any variety of crop planted in the target planting region, remote sensing data of the target planting region within the current cycle;
performing grid division on the remote sensing data, and determining a crop planting density and area of each grid, where the variety of crop is planted within the grid;
dividing, according to the crop planting density and area of each grid, the remote sensing data based on crop planting density levels, and acquiring all grids corresponding to each of the crop planting density levels; and
determining, according to all the grids corresponding to each of the crop planting density levels, a sampling point in the target planting region based on a stratified sampling principle as the target sampling point.

Optionally, the constructing a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain specifically includes:
performing, based on the threshold range of each contaminant and the content of each contaminant in the production stage, the procurement stage, the storage stage, the processing stage, and the sales stage of the target grain and oil product within the current cycle, entity identification and relationship identification on the entities on the grain and oil whole-process holographic traceability chain to obtain multiple entities and relationships between the entities; and
constructing the knowledge graph corresponding to each contaminant based on the entities and the relationships between the entities.

Optionally, before constructing a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain, the method further includes:

storing target acquisition data, monitoring data, and the value of the main influencing factor at each preset location in the target planting region within the current cycle, as well as target acquisition data, monitoring data, and the value of the main influencing factor at each target sampling point, onto the grain and oil whole-process holographic traceability chain, where the target acquisition data includes: latitude and longitude, crop variety, location of plot, and sampling time; and the monitoring data includes: crop production information, crop planting information, crop fertilization and irrigation information, crop pest and disease control information, and the content of each contaminant in the production stage, the procurement stage, the storage stage, the processing stage, and the sales stage of the target grain and oil product.

Optionally, the predicting a content of each contaminant in the procurement stage, the storage stage, the processing stage, and the sales stage of the target grain and oil product within a next cycle based on the knowledge graph corresponding to each contaminant and a content of each contaminant in the production stage of the target grain and oil product within the next cycle to obtain predicted values; and performing prevention control warning based on the predicted values specifically includes:
predicting, for any one of the procurement stage, the storage stage, the processing stage, and the sales stage of the target grain and oil product within the next cycle, the content of each contaminant in the stage within the next cycle based on the knowledge graph corresponding to each contaminant and the content of each contaminant in the production stage of the target grain and oil product within the next cycle to obtain a predicted value; and
performing prevention control warning for any contaminant in the stage within the next cycle, if the predicted value for the content of the contaminant in the stage within the next cycle exceeds a set threshold.

Optionally, the environmental variable includes: an ecological factor and a human activity factor; and the spatial structure variable includes: latitude and longitude, a spatial autocorrelation variable, and a spatial regionalized variable.

Optionally, for any variety of crop planted in the target planting region, a value of the spatial regionalized variable at the preset location in the target planting region is determined by:
processing, for any contaminant, the content of the contaminant in the variety of crop planted at each target sampling point in the target planting region to obtain a processed content of the contaminant in the variety of crop planted at each target sampling point in the target planting region, where the processed content of the contaminant in the variety of crop planted at each target sampling point in the target planting region conforms to a normal distribution;
performing spatial statistics on the processed content of the contaminant in the variety of crop planted at each target sampling point in the target planting region to obtain a high-cluster value range and a low-cluster value range of the target planting region; and
dividing the target planting region into multiple sub-regions according to the high-cluster value range and the low-cluster value range of the target planting region through a natural breaks method, and determining an average value of the contaminant corresponding to each sub-region as the value of the spatial regionalized variable, where the average value of the contaminant corresponding to the sub-region is an average value of the content of the contaminant in the crop planted at each target sampling point within the sub-region for producing the grain and oil product.

Optionally, the performing spatial statistics on the processed content of the contaminant in the variety of crop planted at each target sampling point in the target planting region to obtain a high-cluster value range and a low-cluster value range of the target planting region specifically includes:

performing local Moran's I spatial statistics on the processed content of the contaminant in the variety of crop planted at each target sampling point in the target planting region to obtain the high-cluster value range and the low-cluster value range of the target planting region.

Optionally, a value of the spatial autocorrelation variable at the preset location is determined by:
fitting a semivariogram to obtain a range;
determining, for any preset location, distances between each point in a nearest neighbor point set corresponding to the preset location and the preset location to obtain a distance set corresponding to the preset location, where the nearest neighbor point set corresponding to the preset location includes k nearest neighbor target sampling points to the preset location in the target planting region; and
determining the range and the distance set corresponding to the preset location as the value of the spatial autocorrelation variable at the preset location.

A second aspect of the present disclosure provides a real-time intelligent detection and prevention control warning apparatus for holographic whole-chain grain and oil product quality safety, including:
a contaminant content prediction module, configured to input, for any variety of crop planted in a target planting region, a value of a main influencing factor at each preset location in the target planting region within a current cycle into a contaminant content prediction model corresponding to the variety of crop, and obtain a content of each contaminant in the variety of crop planted at each preset location, where the variety of crop is configured to produce a target grain and oil product; one cycle includes a production stage, a procurement stage, a storage stage, a processing stage, and a sales stage of the target grain and oil product; the contaminant content prediction model corresponding to the variety of crop is generated by training a convolutional neural network model based on the main influencing factor at each target sampling point in the target planting region within the current cycle and the content of the contaminant in the variety of crop planted at each target sampling point; and the main influencing factor is obtained by screening an environmental variable and a spatial structure variable;
a production stage contaminant content determination module, configured to determine the content of each contaminant in the variety of crop planted at each preset location and each target sampling point as a content of each contaminant in the production stage of the target grain and oil product;
a procurement stage contaminant content determination module, configured to determine a content of each contaminant in the variety of crop planted at each preset location and each target sampling point after harvesting as a content of each contaminant in the procurement stage of the target grain and oil product;
a storage and processing stage contaminant content determination module, configured to store the variety of crop planted at each preset location and each target sampling point after procurement into a warehouse, determine a content of each contaminant at warehousing-in as a content of each contaminant in the storage stage of the target grain and oil product, and determine a content of each contaminant at warehousing-out as a content of each contaminant in the processing stage of the target grain and oil product;
a sales stage contaminant content determination module, configured to process the variety of crop after warehousing-out to obtain the target grain and oil product, and determine a content of each contaminant in the target grain and oil product for sale as a content of each contaminant in the sales stage of the target grain and oil product;
a knowledge graph construction module, configured to construct a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain; and
a prevention control warning module, configured to predict a content of each contaminant in the procurement stage, the storage stage, the processing stage, and the sales stage of the target grain and oil product within a next cycle based on the knowledge graph corresponding to each contaminant and a content of each contaminant in the production stage of the target grain and oil product within the next cycle to obtain predicted values; and perform prevention control warning based on the predicted values.

According to specific embodiments provided by the present disclosure, the present has the following technical effects:
The present disclosure provides a real-time intelligent detection and prevention control warning method and apparatus for holographic whole-chain grain and oil product quality safety. The method includes: inputting a value of a main influencing factor at a preset location into a contaminant content prediction model to obtain a content of each contaminant in a crop planted at the preset location; determining a content of each contaminant in the crop planted at the preset location and a target sampling point as a content of each contaminant in a production stage; acquiring a content of each contaminant in the crop after harvesting as a content of each contaminant in a procurement stage; storing a variety of crop planted at each preset location and target sampling point after procurement into a warehouse, determining a content of each contaminant at warehousing-in as a content of each contaminant in a storage stage of a target grain and oil product, and determining a content of each contaminant at warehousing-out as a content of each contaminant in a processing stage of the target grain and oil product; and determining a content of each contaminant in the target grain and oil product for sale as a content of each contaminant in the sales stage of the target grain and oil product. The present disclosure enables real-time monitoring for the content of each contaminant in any stage of production, procurement, storage, processing, and sales of the grain and oil product. The method further includes: predicting a content of each contaminant in the procurement, storage, processing, and sales stages of the target grain and oil product within a next cycle based on a knowledge graph corresponding to each contaminant and the content of each contaminant in the production stage of the target grain and oil product within the next cycle to obtain predicted values, and performing prevention control warning based on the predicted values. Thus, the present disclosure can predict the content of each contaminant in the procurement, storage, processing, and sales stages and implement prevention control warning.

### BRIEF DESCRIPTION OF THE DRAWINGS

To describe the technical solutions in the embodiments of the present disclosure more clearly, the following briefly describes the drawings required for describing the embodiments or the prior art. Apparently, the drawings in the following description show merely some embodiments of the present disclosure, and those of ordinary skill in the art may still derive other drawings from these drawings without creative efforts.

FIG. 1 is a flowchart of a real-time intelligent detection and prevention control warning method for holographic whole-chain grain and oil product quality safety provided by an embodiment of the present disclosure;

FIG. 2 is a schematic diagram of high- and low-cluster value zones divided based on cadmium in rice in a planting region;

FIG. 3 is a semivariogram fitting curve diagram; and

FIGS. 4A-4B are linear fitting result diagrams of model predicted values and measured values.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

To make the above objectives, features, and advantages of the present disclosure more obvious and easy to understand, the present disclosure will be further described in detail with reference to the accompanying drawings and specific implementations.

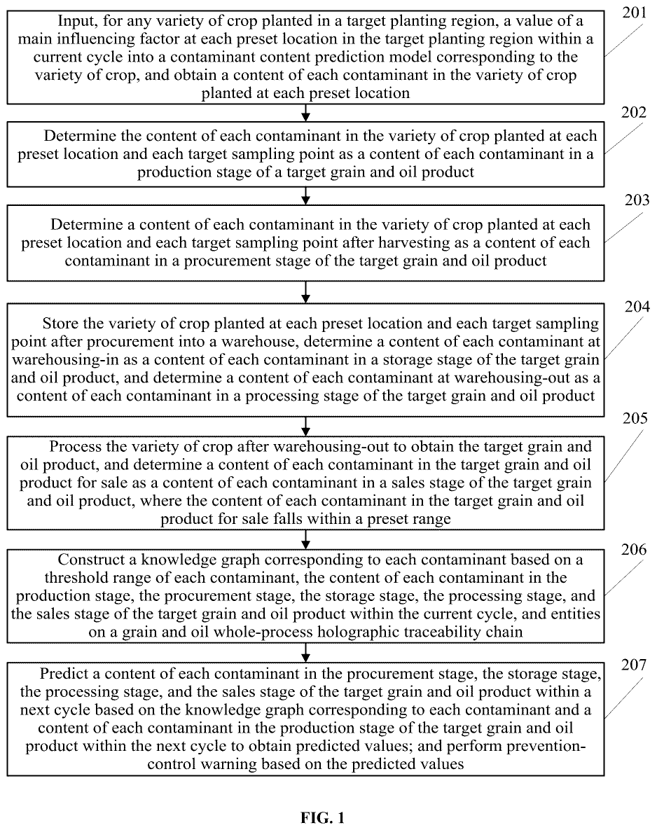

An exemplary embodiment provides a real-time intelligent detection and prevention control warning method for holographic whole-chain grain and oil product quality safety. As shown in FIG. 1, the method includes the following steps.

Step 201: For any variety of crop planted in a target planting region, within a current cycle, a value of a main influencing factor at each preset location in the target planting region is input into a contaminant content prediction model corresponding to the variety of crop to obtain a content of each contaminant in the variety of crop planted at each preset location. The variety of crop is configured to produce a target grain and oil product. One cycle includes a production stage, a procurement stage, a storage stage, a processing stage, and a sales stage of the target grain and oil product. The contaminant content prediction model corresponding to the variety of crop is generated by training a convolutional neural network model based on the main influencing factor at each target sampling point in the target planting region within the current cycle and the content of the contaminant in the variety of crop planted at each target sampling point. The main influencing factor is obtained by screening an environmental variable and a spatial structure variable. The contaminant includes a fungal toxin and a heavy metal.

Step 202: The content of each contaminant in the variety of crop planted at each preset location and each target sampling point is determined as a content of each contaminant in the production stage of the target grain and oil product.

Step 203: The variety of crop planted at each preset location and each target sampling point is harvested, and a content of each contaminant in the harvested variety of crop is determined as a content of each contaminant in the procurement stage of the target grain and oil product.

Step 204: The variety of crop planted at each preset location and each target sampling point is procured and stored into a warehouse, a content of each contaminant at warehousing-in is determined as a content of each contaminant in the storage stage of the target grain and oil product, and a content of each contaminant at warehousing-out is determined as a content of each contaminant in the processing stage of the target grain and oil product.

Step 205: The variety of crop is warehoused out and processed to obtain the target grain and oil product, and a content of each contaminant in the target grain and oil product for sale is determined as a content of each contaminant in the sales stage of the target grain and oil product.

Step 206: Based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain, a knowledge graph corresponding to each contaminant is constructed.

Step 207: A content of each contaminant in the procurement stage, the storage stage, the processing stage, and the sales stage of the target grain and oil product within a next cycle are predicted based on the knowledge graph corresponding to each contaminant and the content of each contaminant in the production stage of the target grain and oil product within the next cycle to obtain predicted values, and prevention control warning is performed based on the predicted values.

The steps 201 to 207 above are implemented to enable real-time monitoring and prevention control warning for the content of the contaminant in any one of the production, procurement, storage, processing, and sales stages of the grain and oil product.

In another exemplary embodiment of the present disclosure, the target sampling point is specifically determined as follows.

For any variety of crop planted in the target planting region, within the current cycle, remote sensing data of the target planting region is acquired.

Grid division is performed on the remote sensing data, and a crop planting density and area of each grid are determined. The variety of crop is planted within the grid.

According to the crop planting density and area of each grid, the remote sensing data is divided based on crop planting density levels, and all grids corresponding to each of the crop planting density levels are acquired.

According to all the grids corresponding to each of the crop planting density levels, a sampling point in the target planting region is determined as the target sampling point based on a stratified sampling principle.

In another exemplary embodiment of the present disclosure, the step that based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain, a knowledge graph corresponding to each contaminant is constructed is specifically as follows.

Based on the threshold range of each contaminant and the content of each contaminant in the production stage, the procurement stage, the storage stage, the processing stage, and the sales stage of the target grain and oil product within the current cycle, entity identification and relationship identification are performed on entities on the grain and oil whole-process holographic traceability chain to obtain multiple entities and relationships between the entities. The grain and oil whole-process holographic traceability chain is configured to trace a source of the grain and oil product.

The knowledge graph corresponding to each contaminant is constructed based on the entities and the relationships between the entities.

In another exemplary embodiment of the present disclosure, before the step that based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain, a knowledge graph corresponding to each contaminant is constructed, the following step is performed.

Target acquisition data, monitoring data, and the value of the main influencing factor at each preset location in the target planting region within the current cycle, as well as target acquisition data, monitoring data, and the value of the main influencing factor at each target sampling point, are stored onto the grain and oil whole-process holographic traceability chain. The target acquisition data includes: latitude and longitude, crop variety, location of plot, and sampling time. The monitoring data includes: crop production information, crop planting information, crop fertilization and irrigation information, crop pest and disease control information, and the content of each contaminant in the production stage, the procurement stage, the storage stage, the processing stage, and the sales stage of the target grain and oil product.

In another exemplary embodiment of the present disclosure, the step that a content of each contaminant in the procurement stage, the storage stage, the processing stage, and the sales stage of the target grain and oil product within a next cycle are predicted based on the knowledge graph corresponding to each contaminant and the content of each contaminant in the production stage of the target grain and oil product within the next cycle to obtain predicted values, and prevention control warning is specifically as follows.

For any one of the procurement stage, the storage stage, the processing stage, and the sales stage of the target grain and oil product within the next cycle, the content of each contaminant in the stage within the next cycle is predicted based on the knowledge graph corresponding to each contaminant and the content of each contaminant in the production stage of the target grain and oil product within the next cycle to obtain a predicted value.

For any contaminant, if the predicted value for the content of the contaminant in the stage within the next cycle exceeds a set threshold, prevention control warning is performed for the contaminant in the stage within the next cycle.

In another exemplary embodiment of the present disclosure, the environmental variable includes: an ecological factor and a human activity factor. The spatial structure variable includes: latitude and longitude, a spatial autocorrelation variable, and a spatial regionalized variable. The ecological factor includes: a soil property, topography, and climate. The human activity factor includes: a road density and agricultural input.

In another exemplary embodiment of the present disclosure, for any variety of crop planted in the target planting region, a value of the spatial regionalized variable at the preset location in the target planting region is determined as follows.

For any contaminant, the content of the contaminant in the variety of crop planted at each target sampling point in the target planting region is processed to obtain a processed content of the contaminant in the variety of crop planted at each target sampling point in the target planting region. The processed content of the contaminant in the variety of crop planted at each target sampling point in the target planting region conforms to a normal distribution.

Spatial statistics is performed on the processed content of the contaminant in the variety of crop planted at each target sampling point in the target planting region to obtain a high-cluster value range and a low-cluster value range of the target planting region.

The target planting region is divided into multiple sub-regions according to the high-cluster value range and the low-cluster value range of the target planting region through a natural breaks method, and an average value of the contaminant corresponding to each sub-region is determined as the value of the spatial regionalized variable. The average value of the contaminant corresponding to the sub-region is an average value of the content of the contaminant in the crop planted at each target sampling point within the sub-region for producing the grain and oil product.

In another exemplary embodiment of the present disclosure, the step that spatial statistics is performed on the processed content of the contaminant in the variety of crop planted at each target sampling point in the target planting region to obtain a high-cluster value range and a low-cluster value range of the target planting region is specifically as follows.

Local Moran's I spatial statistics is performed on the processed content of the contaminant in the variety of crop planted at each target sampling point in the target planting region to obtain the high-cluster value range and the low-cluster value range of the target planting region.

In another exemplary embodiment of the present disclosure, a value of the spatial autocorrelation variable at the preset location is determined as follows.

A semivariogram is fitted to obtain a range.

For any preset location, distances between each point in a nearest neighbor point set corresponding to the preset location and the preset location are determined to obtain a distance set corresponding to the preset location. The nearest neighbor point set corresponding to the preset location includes k nearest neighbor target sampling points to the preset location in the target planting region.

The range and the distance set corresponding to the preset location are determined as the value of the spatial autocorrelation variable at the preset location.

The present disclosure uses the contaminant content prediction model to predict the contaminant in the spatial dimension and the knowledge graph to predict the contaminant content in the temporal dimension. The present disclosure can acquire predicted values for each stage based on the knowledge graph. The present disclosure can determine stages exceeding standards and issue warnings, precisely locate the stage with a product quality problem, and achieve risk prediction and warning during quality control. Therefore, the present disclosure can effectively achieve real-time risk prevention-control throughout the whole chain of the grain and oil product from origin to product, covering “three flows in one” (production flow, logistics flow, and control flow). The present disclosure provides crucial technical support for food quality safety supervision and prevention-control.

The present disclosure provides a specific embodiment using the heavy metal cadmium as an example to detail the above method.

Step 1: In a crop planting and production stage, based on spectral, shape, texture, and other features of a crop, satellite remote sensing data including a planting range and a planting density of the corresponding crop are acquired, with a resolution of 1 km×1 km.

Step 2: Based on the remote sensing data acquired in the Step 1, a sampling quantity and specific sampling locations within a target planting region are determined according to a regional planting density distribution and a planting area. The crop is planted in the target planting region.

Specifically, for any variety of crop in the target planting region, grids with different planting densities and a number of grids are counted. Grids are assigned to corresponding crop planting density levels such that a summed planting area of grids within each crop planting density level accounts for approximately equal proportions of a total planting area. A sampling quantity and sampling points are determined for each level. The latitude and longitude information of the sampling point is converted into a specific sampling address using mapping software.

Taking rice as an example, the satellite remote sensing data for the rice are 1 km×1 km grids with sequential code numbers and latitude and longitude. Each grid corresponds to a rice planting density. The density multiplied by the number of grids gives the corresponding planting region in km². That is, the planting area of an i-th grid is its corresponding rice planting density. The planting areas of all grids are summed to obtain S_{N}. Let L be a total number of crop planting density levels. L can be determined based on the total sampling quantity M (a larger L allows for fully reflecting different planting density levels in the sampling points). An average area is calculated according to

$$S = \frac{{S}_{N}}{L} .$$

Based on the average area and the planting area for each rice planting density, the rice planting area for each crop planting density level is acquired. The rice planting area for each crop planting density level is approximately equal and similar to the average area. All grids corresponding to an 1-th crop planting density level are derived according to

$${S}_{1} = {\sum }_{i = 1}^{n} {s}_{i} ,$$

where Sl denotes a sum of rice planting areas for the 1-th crop planting density level, and sᵢ denotes the planting area of the i-th grid. If the grid density corresponding to the 1-th level includes planting densities a, b, and c, then all grids corresponding to the 1-th level include all grids corresponding to the planting densities a, b, and c. A total number of samples m for each level is calculated according to

$$m = \frac{M}{L} .$$

Based on all the grids corresponding to each level and the total number of samples for each level, the sampling points for each level (i.e., selected grids) are determined. Specifically, regarding which grid to select, a random sampling tool can be used to draw a code number from codes of a corresponding group interval, which will provide the corresponding latitude and longitude, i.e., the sampling point location. One group interval corresponds to one level. Codes within the group interval represent planting density values included in that level. Specific sampling statistics refer to Table 1.

TABLE 1
Example table of sampling statistics

| | | | | Number | Rounded |
|---|---|---|---|---|---|
| Group | Number | Total | Area | of grids | number of |
| interval | of grids | area | percentage | sampled | grids sampled |
| 0-30 | 1628 | 41406 | 10.10% | 8.08 | 8 |
| 31-40 | 1155 | 40998 | 10.00% | 8 | 8 |
| 41-49 | 906 | 40763 | 9.94% | 7.95 | 8 |
| 50-55 | 727 | 38186 | 9.31% | 7.45 | 7 |
| 56-60 | 707 | 41002 | 10.00% | 8 | 8 |
| 61-64 | 621 | 38863 | 9.48% | 7.58 | 8 |
| 65-68 | 587 | 39128 | 9.54% | 7.63 | 8 |
| 69-72 | 557 | 39347 | 9.60% | 7.68 | 8 |
| 73-77 | 571 | 42794 | 10.44% | 8.35 | 8 |
| 78-100 | 583 | 47530 | 11.59% | 9.27 | 9 |
| Total | 8042 | 410017 | 1 | 80 | 80 |

Step 3: During the production stage, after the sampling points are determined, the data of the specific sampling points are transmitted to an unmanned aerial vehicle (UAV). The UAV acquires crop data and target acquisition data at the sampling points, and stores the target acquisition data onto the grain and oil whole-process holographic traceability chain for later use in traceability. The acquired sample (crop from the sampling point) is automatically delivered to an unmanned inspection and testing device for testing relevant quality indicators and safety indicators, thereby acquiring the content of each contaminant. In this embodiment, the content refers to cadmium content. The tested data (cadmium content) is directly and automatically transmitted to the grain and oil whole-process holographic traceability chain, forming monitoring data together with other information from the production stage for later use in traceability. The monitoring data includes: production information, planting information, fertilization and irrigation information, pest and disease control information, cadmium content, etc.

Step 4: An input parameter of the neural network model is determined, and the neural network model is constructed.

Specifically, the environmental variable and spatial structure variable are screened to obtain the main influencing factor as the input parameter through methods such as principal component analysis, correlation analysis, or variance inflation factor testing. The environmental variable includes an ecological factor (soil property, topography, climate, etc.) and a human activity factor (road density, agricultural input, etc.). The spatial structure variable includes geographical location (latitude and longitude), a spatial autocorrelation variable, and a spatial regionalized variable. This step fully considers the environmental variable and the spatial structure variable, making the cadmium content predicted later through the model more accurate.

The spatial regionalized variable is determined as follows.

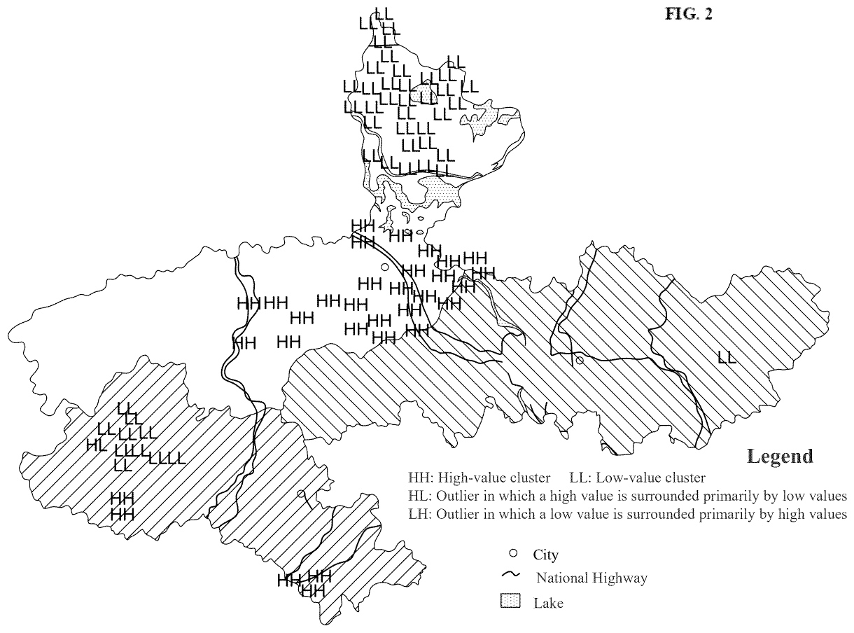

The cadmium content acquired in the Step 3 is processed to make it conform to a normal distribution. Local Moran's I statistics is performed on the processed cadmium content to determine a high-cluster value range and a low-cluster value range of the target planting region, as shown in FIG. 2. According to the high-cluster value range and the low-cluster value range, the target planting region is divided into different sub-regions using a natural breaks method, and an average value of the cadmium content at the sampling points within each sub-region is taken as the spatial regionalized variable.

The spatial autocorrelation variable is determined as follows.

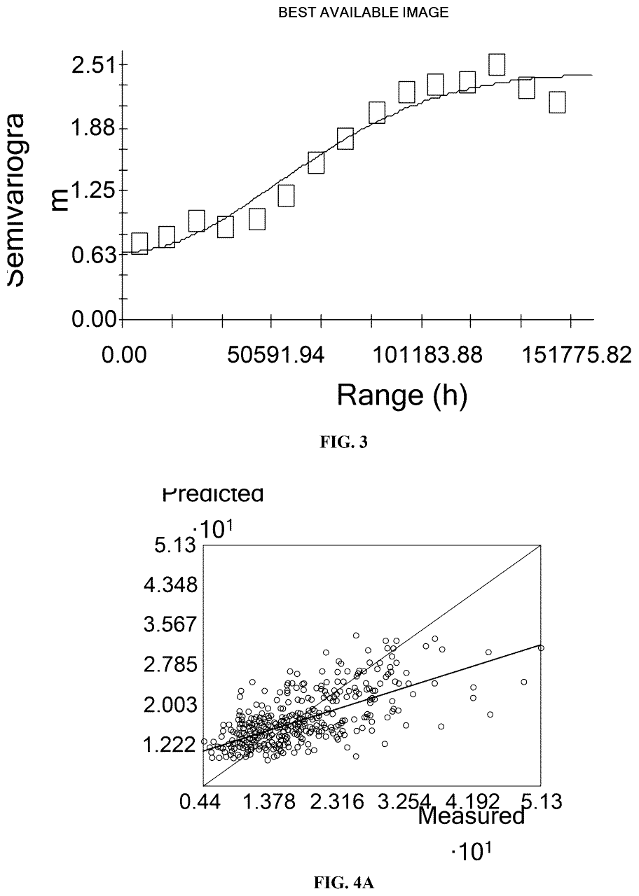

A semivariogram (as shown in FIG. 3) is fitted to obtain a range, with the result shown in Table 2. Distances between the preset location and five nearest neighboring sampling points are calculated to obtain a distance set. The range and the distances within the distance set are taken as the spatial autocorrelation variable.

TABLE 2
Parameters of semivariogram

| Theoretical semivariogram | Low-cluster value zone Gaussian |
|---|---|
| model | function |
| RSS | 0.278 |
| R2 | 0.953 |
| C0/C + C0 | 0.272 |
| C0 | 0661 |
| C + C0 | 2.429 |
| Range A0/m | 75900 |

The environmental variable and spatial structure variable data in the target planting region are characterized as input data. A convolutional neural network model is constructed with rice cadmium content as output data. This convolutional neural network model is a convolutional neural network-rice heavy metal (CNN-RHM) model.

Specifically, the CNN-RHM model includes a convolutional layer, an activation function, a pooling layer, a fully connected layer, and an output layer that are sequentially connected. In the CNN-RHM model, convolution is first performed on the main influencing factor through the convolutional layer to further extract features. There are 10 convolutional kernels, and the size of each convolutional kernel is 3×3, thereby generating 10 feature maps representing different features extracted from the original input data. The stride is set to 1 to ensure consistency between input and output dimensions. The activation function supporting the convolutional layer is added after the convolutional layer. A rectified linear unit (ReLU) activation function is used in this model. Subsequently, the pooling layer is added, using max pooling to improve prediction accuracy, with a pooling window of 2×2 and a stride of 2. The fully connected layer is established after the pooling layer. The fully connected layer is in a chain arrangement, with 100 neurons. Finally, the output layer is added.

Step 5: The neural network model constructed in the Step 4 are trained and validated to generate a cadmium content prediction model.

Specifically, the input data and output data are divided into a training set and a validation set at a ratio of 70%: 30%. The training set is input into the model to train the model with a learning rate of 0.001 through a mean squared error loss function, gradient descent and its variant Adam optimization algorithm. The settings of the convolutional layer, the pooling layer, and the fully connected layer are continuously adjusted to obtain the optimal CNN-RHM model.

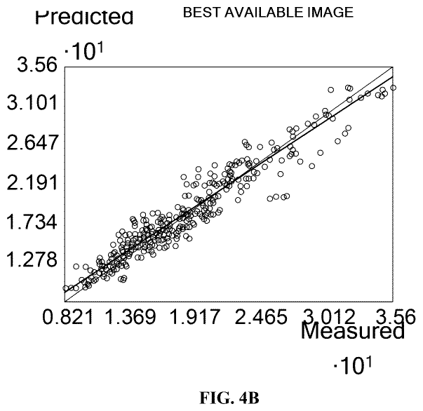

The validation set is input into the trained model, and the model is validated with accuracy evaluation metrics including coefficient of determination (R²), root mean square error (RMSE), and mean absolute error (MAE). Results show that the CNN-RHM model fully considering the environmental variable has higher R² (>0.85) and lower MAE and RMSE, with its predicted value closest to the test result. This indicates that the CNN-RHM model performs well in modeling and prediction. In FIGS. 4A-4B, the black line is generated from linear fitting of the predicted and measured values at the sampling points. When the predicted value equals the measured value, a reference line is provided to observe how close the black line is to the reference line (the diagonal of the coordinate frame). FIGS. 4A-4B show that the CNN-RHM model fully considering the environmental variable and the spatial structure variable performs very well in predicting rice cadmium content in the study area. FIG. 4A shows an ordinary Kriging model considering only the spatial structure variable and not the environmental variable, while FIG. 4B shows the CNN-RHM model fully considering the environmental variable and the spatial structure variable.

Step 6: Based on the cadmium content prediction model obtained in the Step 5, rice cadmium content at preset locations in the target planting region is predicted to obtain predicted values and a distribution map of rice cadmium content across the entire target planting region.

Specifically, the preset locations and their latitude and longitude are determined, and key influencing factors at the preset locations are extracted. The extracted key influencing factors are input into the cadmium content prediction model to obtain predicted values of cadmium content at the preset locations.

Step 7: The predicted values of rice cadmium content obtained in the Step 6 are embedded into the grain and oil whole-process holographic traceability chain, and cadmium content values from other stages are acquired.

Specifically, factors such as irrigation, soil, atmosphere, and pesticide application in the production stage can cause changes in grain cadmium content at this stage. Therefore, cadmium test and prediction are performed during the grain planting stage. The tested and predicted values of cadmium content are automatically assigned to the production stage of the traceability chain via the traceability system. That is, the predicted values of cadmium content obtained in the Step 6 together with the cadmium content sampled in the Step 3 serve as the cadmium content in the production stage and are stored onto the traceability chain.

During procurement of newly harvested grain, cadmium test is performed to obtain the cadmium content in the grain, as the cadmium content in the procurement stage of the target grain and oil product. In the storage stage, since grain is mostly stationary, the impact of cadmium is almost negligible. Therefore, the cadmium content at warehousing-in is determined as the cadmium content in the storage stage of the target grain and oil product. After the grain is warehoused out from the storage stage, the grain is transported to the processing stage. The cadmium content at warehousing-out is determined as the cadmium content in the processing stage. The variety of crop after warehousing-out is processed to obtain the target grain and oil product. The cadmium content of the target grain and oil product is measured and compared with that from the production, procurement, and storage stages. It is determined whether the cadmium content at each stage exceeds the corresponding threshold, and the product not exceeding the threshold is transferred to the sales stage. The cadmium content acquired from the production, procurement, storage, processing, and sales stages are embedded into the whole-process holographic traceability chain of the grain and oil product prevention control warning and traceability system.

Step 8: The knowledge graph is constructed. The constructed knowledge graph is combined with a hazard analysis and critical control point (HACCP) quality system key monitoring point for a heavy metal to perform cadmium prediction and warning along a longitudinal time axis of grain circulation: “production, procurement, storage, processing, and sales”.

Specifically, the original cadmium warning data, i.e., the cadmium threshold range, needed for constructing the knowledge graph, is preliminarily obtained based on national standards.

Based on the cadmium threshold range, the cadmium content in the production stage, the procurement stage, the storage stage, the processing stage, and the sales stage of the target grain and oil product within the current cycle is combined with regional characteristics and climate change, and a natural language processing technology is used to perform entity identification on entities stored in the whole-process holographic traceability chain. Thus, the entities in the grain and oil whole-process holographic traceability chain are identified, such as production enterprises, products, batches, and transportation vehicles. Relationship extraction is performed on the entities to identify relationships between the entities, such as the relationship between the production enterprise and the product, the relationship between the product and the batch, and the relationship between the batch and the transportation vehicle. The entities and the relationships are represented as nodes and edges in the graph. Thus, the knowledge graph corresponding to cadmium is constructed based on the cadmium threshold.

In the next cycle, the cadmium content in other stages is predicted based on the knowledge graph corresponding to cadmium and the cadmium content in the production stage of the next cycle, achieving cadmium content prediction along the longitudinal time axis of “production, procurement, storage, processing, and sales”, combined with the cadmium content safety threshold specified in the HACCP quality system for warning.

A reasoning algorithm is used to infer the knowledge graph so as to discover hidden relationships and patterns between various nodes of the knowledge graph. The knowledge graph is visualized to provide an intuitive graphical interface, facilitating user viewing and analysis.

By constructing the knowledge graph and the contaminant content prediction model, the present disclosure achieves grain product prevention control warning and data monitoring functions, covering the entire process of grain production, procurement, storage, processing, and sales.

Based on the same inventive concept, an embodiment of the present disclosure further provides a real-time intelligent detection and prevention control warning apparatus for holographic whole-chain grain and oil product quality safety, for implementing the aforementioned real-time intelligent detection and prevention control warning method for holographic whole-chain grain and oil product quality safety. The problem-solving solutions provided by the apparatus are similar to those described in the method above. Therefore, specific limitations in one or more embodiments of the real-time intelligent detection and prevention control warning apparatus for holographic whole-chain grain and oil product quality safety can be referred to the limitations of the real-time intelligent detection and prevention control warning method for holographic whole-chain grain and oil product quality safety described above and will not be repeated here.

An exemplary embodiment provides a real-time intelligent detection and prevention control warning apparatus for holographic whole-chain grain and oil product quality safety. The modules of the apparatus are described as follows.

A contaminant content prediction module is configured to input, for any variety of crop planted in a target planting region, a value of a main influencing factor at each preset location in the target planting region within a current cycle into a contaminant content prediction model corresponding to the variety of crop, and obtain a content of each contaminant in the variety of crop planted at each preset location, where the variety of crop is configured to produce a target grain and oil product; one cycle includes a production stage, a procurement stage, a storage stage, a processing stage, and a sales stage of the target grain and oil product; the contaminant content prediction model corresponding to the variety of crop is generated by training a convolutional neural network model based on the main influencing factor at each target sampling point in the target planting region within the current cycle and the content of the contaminant in the variety of crop planted at each target sampling point; and the main influencing factor is obtained by screening an environmental variable and a spatial structure variable.

A production stage contaminant content determination module is configured to determine the content of each contaminant in the variety of crop planted at each preset location and each target sampling point as a content of each contaminant in the production stage of the target grain and oil product.

A procurement stage contaminant content determination module, configured to determine a content of each contaminant in the variety of crop planted at each preset location and each target sampling point after harvesting as a content of each contaminant in the procurement stage of the target grain and oil product.

A storage and processing stage contaminant content determination module is configured to store the variety of crop planted at each preset location and each target sampling point after procurement into a warehouse, determine a content of each contaminant at warehousing-in as a content of each contaminant in the storage stage of the target grain and oil product, and determine a content of each contaminant at warehousing-out as a content of each contaminant in the processing stage of the target grain and oil product.

A sales stage contaminant content determination module is configured to process the variety of crop after warehousing-out to obtain the target grain and oil product, and determine a content of each contaminant in the target grain and oil product for sale as a content of each contaminant in the sales stage of the target grain and oil product.

A knowledge graph construction module is configured to construct a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain.

A prevention control warning module is configured to predict a content of each contaminant in the procurement stage, the storage stage, the processing stage, and the sales stage of the target grain and oil product within a next cycle based on the knowledge graph corresponding to each contaminant and a content of each contaminant in the production stage of the target grain and oil product within the next cycle to obtain predicted values; and perform prevention control warning based on the predicted values.

It should be noted that the user information (including but not limited to user device information and personal information) and data (including but not limited to data for analysis, stored data, and displayed data) covered by the present disclosure are all authorized by users or explicitly permitted by relevant parties. The acquisition, use, and processing of relevant data comply with relevant provisions.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the foregoing embodiments is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

What is claimed is:

1. A real-time intelligent detection and prevention control warning method for holographic whole-chain grain and oil product quality safety, comprising:
inputting, for any variety of crop planted in a target planting region, a value of a main influencing factor at each preset location in the target planting region within a current cycle into a contaminant content prediction model corresponding to the variety of crop, and obtaining a content of each contaminant in the variety of crop planted at each preset location, wherein the variety of crop is configured to produce a target grain and oil product; one cycle comprises a production stage, a procurement stage, a storage stage, a processing stage, and a sales stage of the target grain and oil product; the contaminant content prediction model corresponding to the variety of crop is generated by training a convolutional neural network model based on the main influencing factor at each target sampling point in the target planting region within the current cycle and the content of the contaminant in the variety of crop planted at each target sampling point; and the main influencing factor is obtained by screening an environmental variable and a spatial structure variable;
determining the content of each contaminant in the variety of crop planted at each preset location and each target sampling point as a content of each contaminant in the production stage of the target grain and oil product;
determining a content of each contaminant in the variety of crop planted at each preset location and each target sampling point after harvesting as a content of each contaminant in the procurement stage of the target grain and oil product;
storing the variety of crop planted at each preset location and each target sampling point after procurement into a warehouse, determining a content of each contaminant at warehousing-in as a content of each contaminant in the storage stage of the target grain and oil product, and determining a content of each contaminant at warehousing-out as a content of each contaminant in the processing stage of the target grain and oil product;
processing the variety of crop after warehousing-out to obtain the target grain and oil product, and determining a content of each contaminant in the target grain and oil product for sale as a content of each contaminant in the sales stage of the target grain and oil product;
constructing a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain; and
predicting a content of each contaminant in the procurement stage, the storage stage, the processing stage, and the sales stage of the target grain and oil product within a next cycle based on the knowledge graph corresponding to each contaminant and a content of each contaminant in the production stage of the target grain and oil product within the next cycle to obtain predicted values; and performing prevention control warning based on the predicted values.

2. The real-time intelligent detection and prevention control warning method for holographic whole-chain grain and oil product quality safety according to claim 1, wherein the target sampling point is specifically determined by:
acquiring, for any variety of crop planted in the target planting region, remote sensing data of the target planting region within the current cycle;
performing grid division on the remote sensing data, and determining a crop planting density and area of each grid, wherein the variety of crop is planted within the grid;
dividing, according to the crop planting density and area of each grid, the remote sensing data based on crop planting density levels, and acquiring all grids corresponding to each of the crop planting density levels; and
determining, according to all the grids corresponding to each of the crop planting density levels, a sampling point in the target planting region based on a stratified sampling principle as the target sampling point.

3. The real-time intelligent detection and prevention control warning method for holographic whole-chain grain and oil product quality safety according to claim 1, wherein the constructing a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain specifically comprises:
performing, based on the threshold range of each contaminant and the content of each contaminant in the production stage, the procurement stage, the storage stage, the processing stage, and the sales stage of the target grain and oil product within the current cycle, entity identification and relationship identification on the entities on the grain and oil whole-process holographic traceability chain to obtain multiple entities and relationships between the entities; and
constructing the knowledge graph corresponding to each contaminant based on the entities and the relationships between the entities.

4. The real-time intelligent detection and prevention control warning method for holographic whole-chain grain and oil product quality safety according to claim 1, wherein before constructing a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain, the method further comprises:
storing target acquisition data, monitoring data, and the value of the main influencing factor at each preset location in the target planting region within the current cycle, as well as target acquisition data, monitoring data, and the value of the main influencing factor at each target sampling point, onto the grain and oil whole-process holographic traceability chain, wherein the target acquisition data comprises: latitude and longitude, crop variety, location of plot, and sampling time; and the monitoring data comprises: crop production information, crop planting information, crop fertilization and irrigation information, crop pest and disease control information, and the content of each contaminant in the production stage, the procurement stage, the storage stage, the processing stage, and the sales stage of the target grain and oil product.

5. The real-time intelligent detection and prevention control warning method for holographic whole-chain grain and oil product quality safety according to claim 1, wherein the predicting a content of each contaminant in the procurement stage, the storage stage, the processing stage, and the sales stage of the target grain and oil product within a next cycle based on the knowledge graph corresponding to each contaminant and a content of each contaminant in the production stage of the target grain and oil product within the next cycle to obtain predicted values; and performing prevention control warning based on the predicted values specifically comprises:
predicting, for any one of the procurement stage, the storage stage, the processing stage, and the sales stage of the target grain and oil product within the next cycle, the content of each contaminant in the stage within the next cycle based on the knowledge graph corresponding to each contaminant and the content of each contaminant in the production stage of the target grain and oil product within the next cycle to obtain a predicted value; and
performing prevention control warning for any contaminant in the stage within the next cycle, if the predicted value for the content of the contaminant in the stage within the next cycle exceeds a set threshold.

6. The real-time intelligent detection and prevention control warning method for holographic whole-chain grain and oil product quality safety according to claim 1, wherein the environmental variable comprises: an ecological factor and a human activity factor; and the spatial structure variable comprises: latitude and longitude, a spatial autocorrelation variable, and a spatial regionalized variable.

7. The real-time intelligent detection and prevention control warning method for holographic whole-chain grain and oil product quality safety according to claim 6, wherein for any variety of crop planted in the target planting region, a value of the spatial regionalized variable at the preset location in the target planting region is determined by:
processing, for any contaminant, the content of the contaminant in the variety of crop planted at each target sampling point in the target planting region to obtain a processed content of the contaminant in the variety of crop planted at each target sampling point in the target planting region, wherein the processed content of the contaminant in the variety of crop planted at each target sampling point in the target planting region conforms to a normal distribution;
performing spatial statistics on the processed content of the contaminant in the variety of crop planted at each target sampling point in the target planting region to obtain a high-cluster value range and a low-cluster value range of the target planting region; and
dividing the target planting region into multiple sub-regions according to the high-cluster value range and the low-cluster value range of the target planting region through a natural breaks method, and determining an average value of the contaminant corresponding to each sub-region as the value of the spatial regionalized variable, wherein the average value of the contaminant corresponding to the sub-region is an average value of the content of the contaminant in the crop planted at each target sampling point within the sub-region for producing the grain and oil product.

8. The real-time intelligent detection and prevention control warning method for holographic whole-chain grain and oil product quality safety according to claim 7, wherein the performing spatial statistics on the processed content of the contaminant in the variety of crop planted at each target sampling point in the target planting region to obtain a high-cluster value range and a low-cluster value range of the target planting region specifically comprises:
performing local Moran's I spatial statistics on the processed content of the contaminant in the variety of crop planted at each target sampling point in the target planting region to obtain the high-cluster value range and the low-cluster value range of the target planting region.

9. The real-time intelligent detection and prevention control warning method for holographic whole-chain grain and oil product quality safety according to claim 6, wherein a value of the spatial autocorrelation variable at the preset location is determined by:
fitting a semivariogram to obtain a range;
determining, for any preset location, distances between each point in a nearest neighbor point set corresponding to the preset location and the preset location to obtain a distance set corresponding to the preset location, wherein the nearest neighbor point set corresponding to the preset location comprises k nearest neighbor target sampling points to the preset location in the target planting region; and
determining the range and the distance set corresponding to the preset location as the value of the spatial autocorrelation variable at the preset location.

10. A real-time intelligent detection and prevention control warning apparatus for holographic whole-chain grain and oil product quality safety, comprising:
a contaminant content prediction module, configured to input, for any variety of crop planted in a target planting region, a value of a main influencing factor at each preset location in the target planting region within a current cycle into a contaminant content prediction model corresponding to the variety of crop, and obtain a content of each contaminant in the variety of crop planted at each preset location, wherein the variety of crop is configured to produce a target grain and oil product; one cycle comprises a production stage, a procurement stage, a storage stage, a processing stage, and a sales stage of the target grain and oil product; the contaminant content prediction model corresponding to the variety of crop is generated by training a convolutional neural network model based on the main influencing factor at each target sampling point in the target planting region within the current cycle and the content of the contaminant in the variety of crop planted at each target sampling point; and the main influencing factor is obtained by screening an environmental variable and a spatial structure variable;
a production stage contaminant content determination module, configured to determine the content of each contaminant in the variety of crop planted at each preset location and each target sampling point as a content of each contaminant in the production stage of the target grain and oil product;
a procurement stage contaminant content determination module, configured to determine a content of each contaminant in the variety of crop planted at each preset location and each target sampling point after harvesting as a content of each contaminant in the procurement stage of the target grain and oil product;
a storage and processing stage contaminant content determination module, configured to store the variety of crop planted at each preset location and each target sampling point after procurement into a warehouse, determine a content of each contaminant at warehousing-in as a content of each contaminant in the storage stage of the target grain and oil product, and determine a content of each contaminant at warehousing-out as a content of each contaminant in the processing stage of the target grain and oil product;
a sales stage contaminant content determination module, configured to process the variety of crop after warehousing-out to obtain the target grain and oil product, and determine a content of each contaminant in the target grain and oil product for sale as a content of each contaminant in the sales stage of the target grain and oil product;
a knowledge graph construction module, configured to construct a knowledge graph corresponding to each contaminant based on a threshold range of each contaminant, the content of each contaminant in the production stage, the procurement stage, the storage stage, the processing stage, and the sales stage of the target grain and oil product within the current cycle, and entities on a grain and oil whole-process holographic traceability chain; and
a prevention control warning module, configured to predict a content of each contaminant in the procurement stage, the storage stage, the processing stage, and the sales stage of the target grain and oil product within a next cycle based on the knowledge graph corresponding to each contaminant and a content of each contaminant in the production stage of the target grain and oil product within the next cycle to obtain predicted values; and perform prevention control warning based on the predicted values.
